(19) United States
(12) Patent Application Publication
(10) Pub. No.: US 2019/0041287 A1
(43) Pub. Date: Feb. 7, 2019

(54) Tap Detection Device

(71) Applicant: Casio Computer Co., Ltd., Tokyo (JP)

(72) Inventor: Tatsuya Sekitsuka, Kunitachi-shi (JP)

(21) Appl. No.: 16/027,556

(22) Filed: Jul. 5, 2018

(30) Foreign Application Priority Data
Aug. 1, 2017 (JP) 2017-148876

(51) Int. Cl. G01L 19/00; G01L 19/06

(52) U.S. Cl. CPC G01L 19/0092; G01L 19/0654

(57) ABSTRACT

A tap detection device includes a housing; an atmospheric pressure sensor provided inside the housing; a processor. The processor is configured to perform atmospheric pressure value acquisition processing acquiring an atmospheric pressure value detected with the atmospheric pressure sensor; and tap detection processing specifying a tap on the housing, based on a result of first determination as to whether the atmospheric pressure value has changed with a predetermined first pattern.

### CROSS-REFERENCE TO RELATED APPLICATIONS

This application is based upon and claims the benefit of priority from prior Japanese Patent Application No. 2017-148876, filed Aug. 1, 2017, the entire contents of which are incorporated herein by reference.

### FIELD OF THE INVENTION

The present invention relates to a tap detection device.

### BACKGROUND OF THE INVENTION

There are known devices equipped with various sensors including an acceleration sensor to detect the moving state and the like of a moving object. As a type of such devices, for example, wearable devices are known. Such a wearable device is attached to the body of the user, to record history of the movement state of the user.

In such a device, the following techniques are known. When the device is slightly patted, the tapping is specified as a tap operation on the basis of a detection result of the acceleration sensor. For example, Japanese Patent Application KOKAI Publication No. 2016-38807 discloses an information processing apparatus performing the following processing to prevent erroneous detection of oscillation derived from movement other than a tap operation as a tap operation, in a device detecting a tap operation using an acceleration sensor. Specifically, the information processing apparatus uses a triaxial acceleration sensor. When acceleration exceeding a predetermined value is detected for any of the three axes, the information processing apparatus determines that the movement is a tap operation, when a difference of the acceleration from accelerations detected for the other axes is larger than a predetermined value.

### SUMMARY OF THE INVENTION

According to an aspect of the invention, a tap detection device includes a housing; an atmospheric pressure sensor provided inside the housing and configured to detect atmospheric pressure inside the housing; a processor; and a storage storing a program to be executed with the processor. The processor is configured to perform, with the program stored in the storage, atmospheric pressure value acquisition processing acquiring an atmospheric pressure value detected with the atmospheric pressure sensor; and tap detection processing specifying a tap on the housing, based on a result of first determination as to whether the atmospheric pressure value has changed with a predetermined first pattern.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention. The components in the drawings are not necessarily to scale relative to each other.

FIG. 1 is a diagram illustrating an example of an external appearance of a wearable sensor according to an embodiment of the present invention;

FIG. 2 is a diagram illustrating an example of an external appearance of the wearable sensor according to an embodiment when a surface cover of the wearable sensor is removed;

FIG. 3 is a block diagram illustrating an outline of a configuration example of the wearable sensor according to an embodiment;

FIG. 4 is a flowchart illustrating an outline of an example of a main operation of the wearable sensor according to an embodiment;

FIG. 5 is a flowchart illustrating an outline of an example of a tap detection operation with an atmospheric pressure sensor;

FIG. 6 is a diagram illustrating an example of change in atmospheric pressure detected with the atmospheric pressure sensor with respect to time;

FIG. 7 is a flowchart illustrating an outline of an example of a double tap detection operation with the atmospheric pressure sensor according to a second method;

FIG. 8 is a flowchart illustrating an outline of an example of a tap detection operation with an acceleration sensor and the atmospheric pressure sensor according to a third method;

FIG. 9 is a diagram illustrating an example of change in atmospheric pressure detected with the atmospheric pressure sensor with respect to time, and change in acceleration detected with the acceleration sensor with respect to time;

FIG. 10 is a diagram for explaining change in acceleration detected with the acceleration sensor and corresponding to a tap operation;

FIG. 11 is a diagram for explaining change in acceleration detected with the acceleration sensor and not corresponding to a tap operation;

FIG. 12 is a diagram for explaining change in acceleration detected with the acceleration sensor and corresponding to a tap operation;

FIG. 13 is a diagram for explaining change in acceleration detected with the acceleration sensor and occurring when the wearer of the wearable sensor is running; and

FIG. 14 is a flowchart illustrating an outline of an example of a double tap detection operation with the acceleration sensor and the atmospheric pressure sensor according to a fourth method.

### DETAILED DESCRIPTION OF THE PREFERRED EMBODIMENTS

The following is an explanation of an embodiment of the present invention, with reference to drawings. The present embodiment relates to a wearable sensor. The wearable sensor includes an atmospheric pressure sensor, an acceleration sensor, a magnetic sensor, an angular velocity sensor, and a GPS sensor, and records history of movement of the person who wears the wearable sensor.

By integrating the angular velocities detected with the angular velocity sensor along the lapse of time, that is, by rotating the attitude along the lapse of time and performing tracking, the attitude of the wearable sensor can be determined with high accuracy. However, the detection value of the angular velocity sensor has an error. When the detection results are integrated, errors also accumulate, and the calculated attitude becomes distant from the accurate value. For this reason, the error of the calculated attitude of the wearable sensor is estimated, on the basis of the gravity direction and the magnetism direction measured using the acceleration sensor and the magnetic sensor having fixed positional relation with the angular velocity sensor, to correct the attitude. The height of the wearable sensor can be determined using the detection value of the GPS sensor and/or the detection of the atmospheric pressure sensor. The position of the wearable sensor can be determined using the detection value of the GPS sensor. In this manner, the wearable sensor acquires information relating to its position and attitude.

The wearable sensor according to the present embodiment includes only a small number of operating buttons, as an operation unit to receive user's inputs, to achieve miniaturization. However, the present wearable sensor receives instructions from the user using also detection results of the various sensors included in the present wearable sensor, to receive various operations. Specifically, the wearable sensor detects that the wearable sensor has been slightly patted, using detection results of the various sensors. In this description, an operation of slightly patting the wearable sensor is referred to as “tap”. In the wearable sensor according to the present embodiment, a predetermined operation is assigned to a tap operation.

[Configuration of Wearable Sensor]

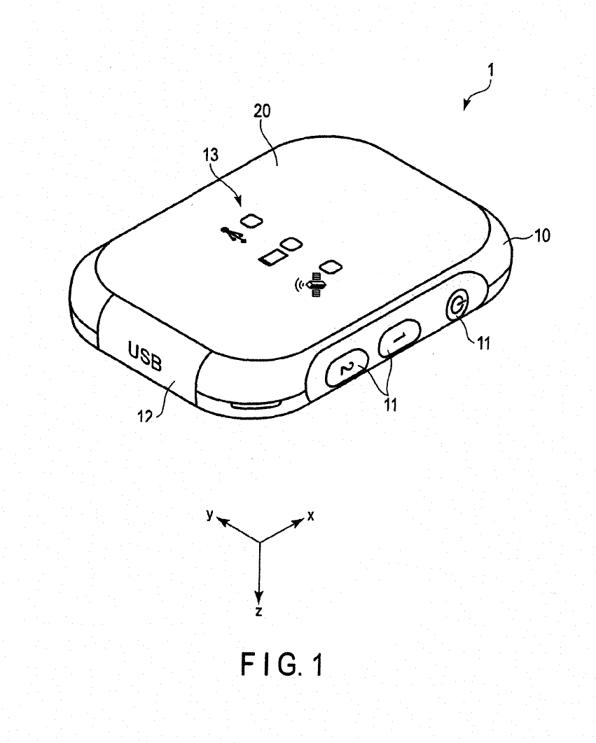

FIG. 1 is a diagram illustrating an outline of an external appearance of a wearable sensor 1 according to the present embodiment. The schematic external shape of the wearable sensor 1 is a chamfered thin rectangular parallelepiped shape. The wearable sensor 1 is attached to, for example, a part around the spinal column of the user's waist such that the wide surface of the wearable sensor 1 extends along the user's back and the long sides of the wide surface are directed to a direction in which the spinal column extends.

In the present embodiment, an x axis and a y axis are defined to mutually cross at right angles, on the wide surface of the wearable sensor 1. The direction of the x axis is defined to extend along the direction of the user's head when the wearable sensor 1 is attached to the user, and the direction of the y axis is defined to extend along the direction of the left side of the user when the wearable sensor 1 is attached to the user. A z axis is also defined to cross the x axis and the y axis at right angles. The direction of the z axis is defined to extend along the direction of the back of the user.

The wearable sensor 1 includes a sensor main body 10 and a surface cover 20. The wearable sensor 1 is provided with input buttons 11, a connection terminal 12, and a display region 13.

The input buttons 11 includes buttons for the user to input instructions to change the state of the wearable sensor 1, such as a power button to turn on/off the power, and a button to select the function.

The connection terminal 12 is a terminal to connect the wearable sensor 1 with an external, device. For example, universal serial bus (USB) is used for connection, and a USB terminal may be adopted as the connection terminal 12 of the wearable sensor 1. The method for connection with external devices is not limited to USB, but another standard may be used. In addition, wireless communication, such as Wi-Fi or Bluetooth, may be used for communication with external devices. In the case where wireless communication is used, the connection terminal 12 may be replaced with an antenna.

The display region 13 is a region indicating the state of the wearable sensor 1.

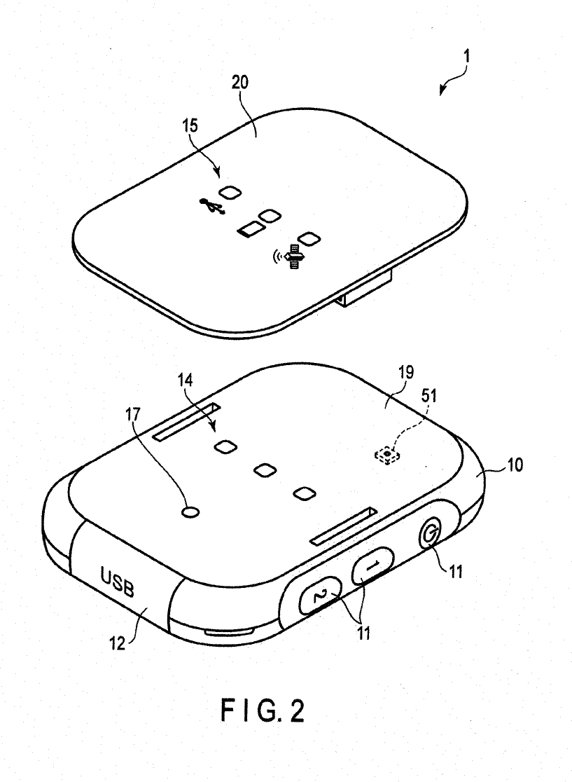

FIG. 2 is a diagram illustrating an outline of the state in which the surface cover 20 is removed from the sensor main body 10. A housing 19 of the sensor main body 10 from which the surface cover 20 has been removed has a waterproof and dustproof function to prevent water and dust from entering the inside thereof.

Part of a portion of the housing 19 covered with the surface cover 20 is provided with a waterproof ventilation film 17. The waterproof ventilation film 17 is a film that does not transmit water but transmits air. Specifically, the waterproof ventilation film 17 is a filter having air permeability and a waterproof and dustproof function. The housing 19 has a waterproof and dustproof structure as a whole, while the inside of the housing 19 and the outside of the wearable sensor 1 perform air exchange, through the space between, the housing 19 and the surface cover 20 and the waterproof ventilation film 17. By exchange of the air, an atmospheric pressure sensor 51 provided inside the housing 19 is enabled to measuring the atmospheric pressure outside the wearable sensor 1. However, because the waterproof ventilation film 17 has a small area, the air in the housing 19 does not rapidly go out or enter through the waterproof ventilation film 17. As described above, the waterproof ventilation film 17 is configured to maintain the air permeability between the inside and the outside of the housing 19 and waterproofness of the housing 19.

The housing 19 is provided with display lamp windows 14 corresponding to the display region 13. Under the display lamp windows 14 inside the housing 19, for example, light-emitting diodes (LED) (not illustrated) are provided, to indicate the state of the wearable sensor 1. In addition, display windows 15 are provided in positions of the surface cover 20 corresponding to the display lamp window 14. This structure enables light of the LEDs and the like to be visually recognized from the outside or the surface cover 20. A liquid crystal display or the like may be used instead of the LEDs.

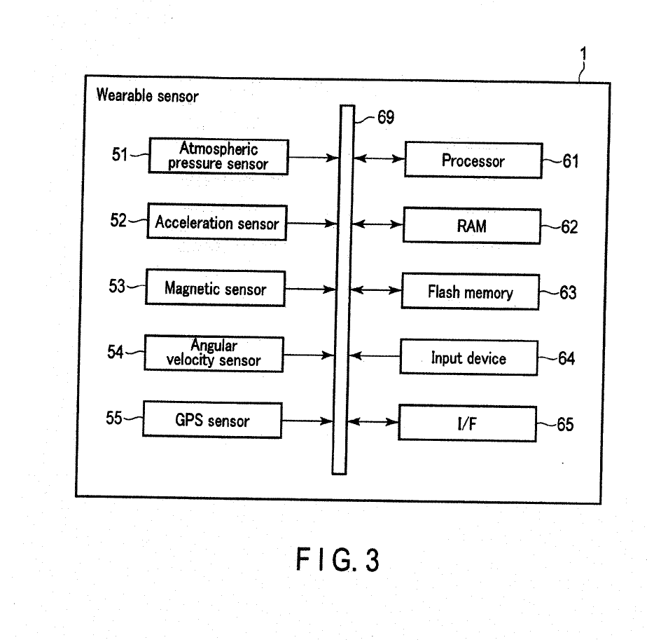

FIG. 3 is a block diagram illustrating the outline of the configuration of sensors and circuits and the like provided inside the housing 19. The wearable sensor 1 includes the atmospheric pressure sensor 51, an acceleration sensor 52, a magnetic sensor 53, an angular velocity sensor 54, a GPS sensor 55, a processor 61, a random access memory (RAM) 62, a flash memory 63, an input device 64, and an interface (I/F) 65 that are mutually connected through a bus line 69.

The wearable sensor 1 stores detection results of the atmospheric pressure, the acceleration, the magnetic direction, the angular velocity, and the position detected with the atmospheric pressure sensor 51, the acceleration sensor 52, the magnetic sensor 53, the angular velocity sensor 54, and the GPS sensor 55, respectively, for a desired period, in the flash memory 63. The wearable sensor 1 also stores analysis results performed on the basis of detection results of the various sensors in the flash memory 63. An external device of the wearable sensor 1 connected with the wearable sensor 1 reads, for example, information relating to the atmospheric pressure, the angular velocity, the acceleration, the magnetic direction, and the position for the desired period and the analysis results recorded in the wearable sensor 1. The external device performs analysis on the basis of them, to calculate the position and the attitude of the wearable sensor 1, and display various types of information.

The atmospheric pressure sensor 51 is an atmospheric pressure sensor using capacitance, piezoresistance, or a strain gauge, and detects the atmospheric pressure in the housing 19, and detects the atmospheric pressure outside the wearable sensor 1. The acceleration sensor 52 has a structure in which, for example, MEMS acceleration sensors are provided in three axis directions, and detects acceleration of each of the axial directions. The gravity direction is determined on the basis of the detection result of the acceleration sensor 52. The magnetic sensor 53 is, for example, a triaxial magnetic sensor, and detects the magnetic direction. For example, the magnetic sensor 53 detects geomagnetism, to detect the azimuth. The angular velocity sensor 54 has a structure in which, for example, MEMS angular velocity sensors are provided in three axis directions, and detects the angular velocity around each of the axes. The GPS sensor 55 receives a signal from a GPS satellite, and prepares positional information of the wearable sensor 1.

The processor 61 is an integrated circuit, such as a central processing unit (CPU), an application specific integrated circuit (ASIC), or a field programmable gate array (FPGA), and performs various types of signal processing. The RAM 62 functions as a main memory of the processor 61. The flash memory 63 stores various types of information, such as programs used in the processor 61 and parameters. The flash memory 63 also stores atmospheric pressure information, angular velocity information, acceleration information, magnetic information, and positional information and the like detected with the atmospheric pressure sensor 51, the acceleration sensor 52, the magnetic sensor 53, the angular velocity sensor 54, and the GPS sensor 55 and processed with the processor 61. The flash memory 63 may also store analysis results and the like obtained on the basis of the atmospheric pressure information, the angular velocity information, the acceleration information, the magnetic information, and the positional information and the like. The RAM 62 and the flash memory 63 are not limited thereto, but may be replaced with various storage devices. The input device 64 includes the input buttons 11 described above. The input device 64 is a device receiving user's inputs, such as a switch, and receives instructions, such as instructions to start up the wearable sensor 1, start measurement, and end measurement. The I/F 65 is an interface to perform transmission and reception of data to and from the outside of the wearable sensor 1. The I/F 65 includes the connection terminal 12 described above.

### [Operations of Wearable Sensor]

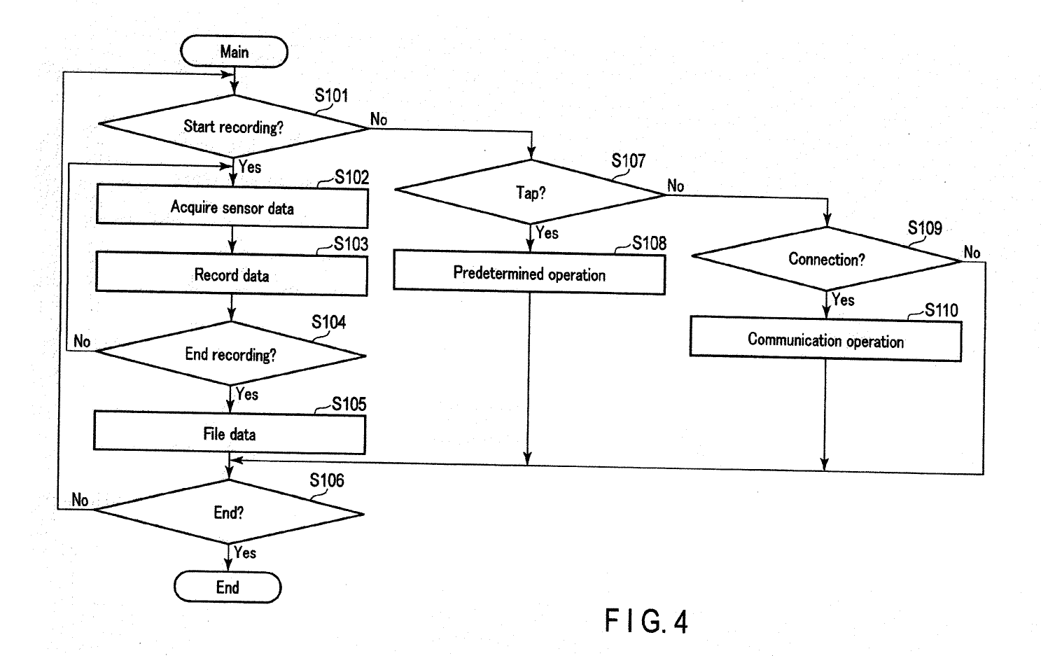

The following is an explanation of an outline of operations of the wearable sensor 1, with reference to the flowchart illustrated in FIG. 4. This process is started when, for example, the power button of the wearable sensor 1 is pressed and the wearable sensor 1 is started up.

At step S101, the processor 61 determines whether an instruction to start recording relating to the position and the attitude of the wearable sensor 1 has been input using, for example, the input button 11. When an instruction to start recording has been input, the process proceeds to step S102. The processor 61 acquires data from the various sensors at step S102, and temporarily stores the acquired data in the flash memory 63 at step S103. At step S104, the processor 61 determines whether an instruction to end recording has been input. When the recording is not to be ended, the process returns to step S102, to continue acquisition of sensor data and recording.

At step S104, when it is determined to end recording, the process proceeds to step S105. At step S105, the processor 61 files data relating to detection values of the sensors, on the basis of the temporary data stored in the flash memory 63, and stores the formed file in the flash memory 63. Thereafter, the process proceeds to step S106.

At step S106, the processor 61 determines whether to end the process. For example, when the power button of the wearable sensor 1 is pressed, the processor 61 determines the process is to be ended. When the process is ended, the present main process is ended. By contrast, when it is determined that the process is not to be ended, the process returns to step S101.

When it is determined at step S101 that recording is not to be started, the process proceeds to step S107. At step S107, the processor 61 determines whether any tap operation relating to the present embodiment has been performed. When a tap operation has been performed, the process proceeds to step S108. At step S108, the processor 61 performs a predetermined operation assigned to the tap operation. Thereafter, the process proceeds to step S106.

When it is determined at step S107 that no tap operation has been performed, the process proceeds to step S109. At step S109, the processor 61 determines whether any cable is connected with the connection terminal 12. When no cable is connected, the process proceeds to step S106. When any cable is connected, the process proceeds to step S110. At step S110, the processor 61 performs an operation of communication with the external device. The communication includes, for example, transmission of a file relating to the detection value of the sensors and stored in the flash memory 63, and/or communication relating to edit of the file. After the communication operation, the process proceeds to step S106.

As described above, the wearable sensor 1 according to the present embodiment records data of the various sensors, communicates with the external device, and performs a predetermined operation corresponding to a tap operation. The present embodiment illustrates that a tap operation as an operation other than the operation relating to start or end of data recording or connection, but the operation relating to start or end of data recording or connection may be performed with a tap operation. The following is an explanation of some examples of determination at step S107 as to whether a tap operation has been performed, that is, a method for detecting a tap operation.

### <First Method>

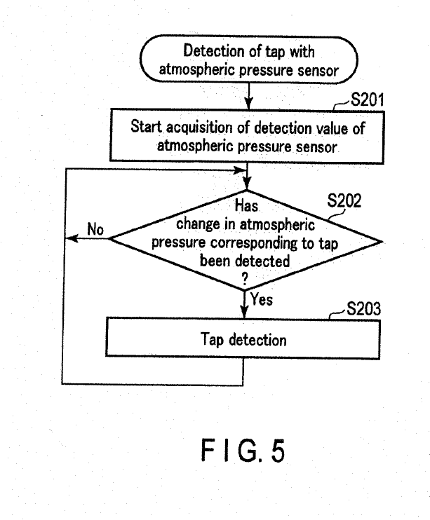

The following is a method for detecting a tap operation using the detection value of the atmospheric pressure sensor 51, as the first method, with reference to the flowchart illustrated in FIG. 5. When the wearable sensor 1 is tapped, that is, when pressure is applied to the wearable sensor 1, the atmospheric pressure inside the housing 19 of the wearable sensor 1 is changed. The change in atmospheric pressure is detected with the atmospheric pressure sensor 51 provided inside the housing 19.

At step S201, the processor 61 starts acquisition of the detection value of the atmospheric pressure sensor 51. Thereafter, the processor 61 acquires and processes the detection value of the atmospheric pressure sensor 51 as the atmospheric pressure value in a predetermined sampling cycle.

At step S202, the processor 61 determines whether any change in atmospheric pressure corresponding to a tap operation has been detected. The process repeats step S202, until change in atmospheric pressure corresponding to a tap operation is detected.

When change in atmospheric pressure corresponding to a tap operation has been detected, the process proceeds to step S203. At step S203, the processor 61 specifies that a tap has been detected. In this state, at step S107 in the main process explained with reference to FIG. 4, it is determined that a tap operation has been performed, and a predetermined operation corresponding to a tap operation is performed at step S108.

After tap detection at step S203, the process returns to step S202, and the process relating to detection of a tap operation is repeated until the next tap operation is detected.

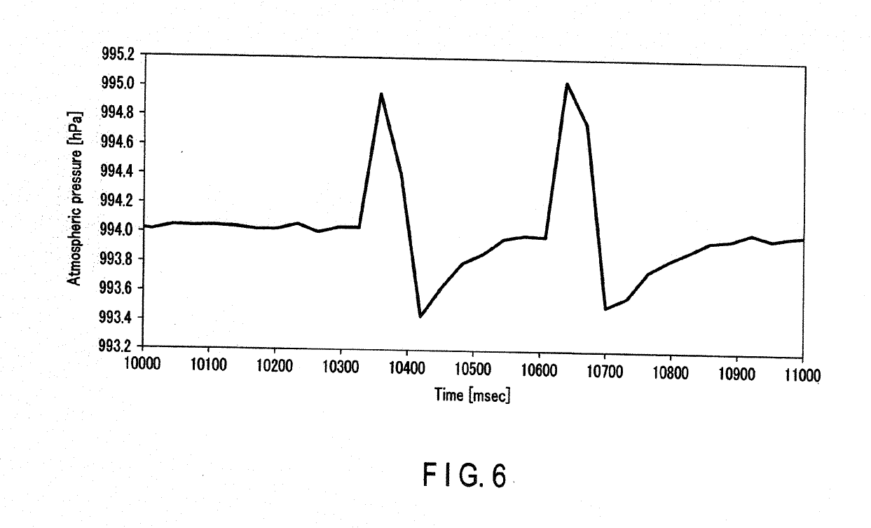

FIG. 6 illustrates an example of the detection value of the atmospheric pressure sensor 51 with respect to lapse of time. In a period at the time from 10300 msec to 10400 msec, the detected atmospheric pressure instantaneously increases. In a period at the time from 10400 msec to 10600 msec, the atmospheric pressure decreases conversely, and thereafter gradually returns to the atmospheric pressure before the change. Such change in atmospheric pressure is caused by a tap on the sensor main body 10 of the wearable sensor 1. The atmospheric pressure increases due to warping the housing 19 inside. Thereafter, the atmospheric pressure decreases due to warping outside as a reaction, and thereafter returns to its original value due to returning of the housing 19 to the original state. In this method, the processor 61 determines that a tap operation has occurred, when a change pattern of the atmospheric pressure like this is detected, that is, a pattern in which the atmospheric pressure instantaneously increases and thereafter decreases, and returns to its original value, for several hundred milliseconds.

As described above, for example, when the change pattern of the atmospheric pressure as described above is defined as the first pattern, the processor 61 acquires the atmospheric pressure value detected with the atmospheric pressure sensor 51, performs first determination as to whether the atmospheric pressure value changes with the first pattern, and specifies that the housing 19 has been tapped, on the basis of the result of the first determination.

The first example enables determination of a user's input of tapping the wearable sensor 1, on the basis of change with time in detection result of the atmospheric pressure sensor 51. By using such a user's input, the wearable sensor 1 is enabled to receive various operations, even when the wearable sensor 1 includes a limited number of buttons as the input device 64.

### <Second Method>

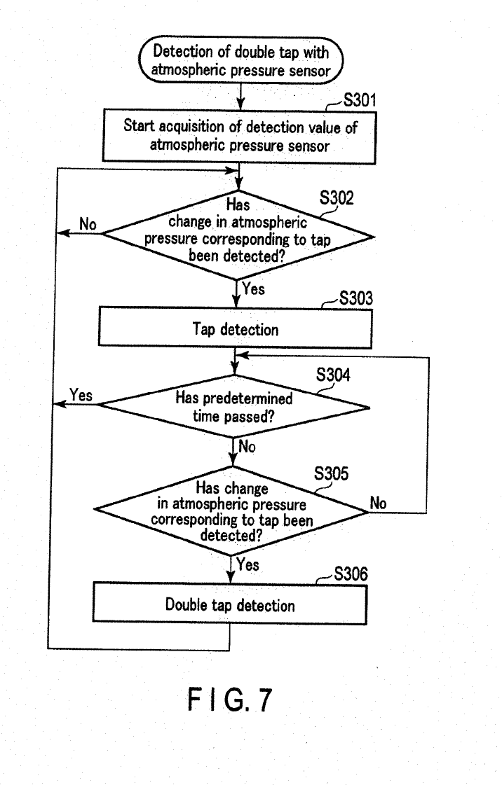

The following is a method for detecting a double tap using the detection value of the atmospheric pressure sensor 51, as the second method, with reference to the flowchart illustrated in FIG. 7. The double tap means an operation in which two tap operations are successively performed within a predetermined period. Detection of a double tap is performed using the detection of a tap operation using the atmospheric pressure sensor 51 explained in the first method.

At step S301, the processor 61 starts acquisition of the detection value of the atmospheric pressure sensor 51.

At step S302, the processor 61 determines whether any change in atmospheric pressure corresponding to a tap operation has been detected. The process repeats step S302, until change in atmospheric pressure corresponding to a tap operation is detected. When change in atmospheric pressure corresponding to a tap operation has been detected, the process proceeds to step S303. At step S303, the processor 61 specifies that a tap has been detected. The tap detected at this step is a first tap. Thereafter, the process proceeds to step S304.

At step S304, the processor 61 determines whether a predetermined period has passed after the first tap is detected. The predetermined period is, for example, set to short time, such as 200 msec to 600 msec, but is not limited thereto. When no predetermined period has passed, the process proceeds to step S305. At step S305, the processor 61 determines whether another change in atmospheric pressure corresponding to a tap operation has been detected. When no change in atmospheric pressure corresponding to a tap operation has been detected, the process returns to step S304. Specifically, the processing at step S304 and the processing at step S305 are repeated, until the predetermined period passes, or change in atmospheric pressure corresponding to a second tap operation is detected.

When it is determined at step S305 that a tap operation has been detected, the process proceeds to step S306. At step S306, the processor 61 specifies that a double tap has been detected. In this state, at step S107 in the main process explained with reference to FIG. 4, it is determined that a double tap operation has been performed, and a predetermined operation corresponding to a double tap operation is performed at step S108.

Thereafter, the process returns to step S302, and the process is repeated from detection of a first tap.

When it is determined at step S304 that the predetermined period has passed, the process returns to step S302, and the process is repeated from detection of a first tap. In this state, the processor 61 determines that no double tap is detected, but a single tap with only one tap has been detected.

In the case of the example of the detection value of the atmospheric pressure sensor 51 with respect to lapse of time illustrated in FIG. 6, after the first tap detected in the period from the time of 10300 msec to 10600 msec, the second tap is detected in the period from the time of 10600 msec to 10900 msec. For example, when the predetermined period determined at step S304 is set to a period of approximately 200 msec to 600 msec, a double tap is detected in the detection value of the atmospheric pressure sensor 51 as illustrated in FIG. 6.

The second method enables determination of a user's input of tapping the wearable sensor 1, on the basis of change with time of the detection result of the atmospheric pressure sensor 51, in the same manner as the first method. In addition, the second method enables detection of a single tap and a double tap. Different operations may be assigned to the single tap and the double tap. This configuration enables detection of two types of operations, by determining a single tap and a double tap discriminated from each other. As another example, no operation may be assigned to a single tap, and an operation may be assigned to only a double tap. In this case, when two taps are not detected within the predetermined period, the tap is not detected as an operation. For example, in the case where a back surface (not illustrated) of the wearable sensor 1 illustrated in FIG. 1 includes an attachment clip to attach the wearable sensor 1 to the user's belt or the like, when the attachment clip is changed from the opened state to the closed state, change in atmospheric pressure like a tap may be detected and erroneously detected as a tap. In a double tap, no double tap occurs unless the user explicitly performs two taps within the predetermined period. For this reason, in detection of a double tap, erroneous detection reduces in comparison with detection of a single tap, and detection accuracy is improved.

This description illustrates an example of a double tap in which the wearable sensor 1 is successively tapped twice, but the number of successive taps may be any number.

### <Third Method>

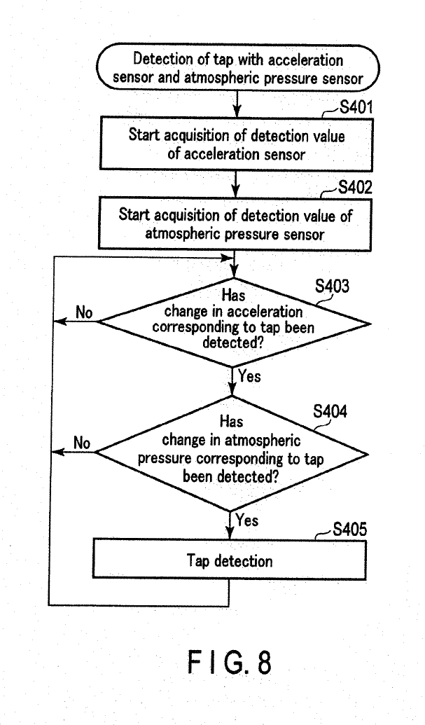

The following is an explanation of a method for detecting a tap using the detection value of the acceleration sensor 52 and the detection value of the atmospheric pressure sensor 51, as the third method, with reference to the flowchart illustrated in FIG. 8. When the wearable sensor 1 is tapped, acceleration corresponding to the tap occurs in the wearable sensor 1. The processor 61 detects the change in acceleration using the acceleration sensor 52 provided in the wearable sensor 1. In addition, in the same manner as the first method, the processor 61 determines change in atmospheric pressure occurring inside the sensor main body 10 of the wearable sensor 1, directly after detection of acceleration, and determines that the wearable sensor 1 has been tapped, when change in acceleration and change in atmospheric pressure are detected.

At step S401, the processor 61 starts acquisition of the detection value of the acceleration sensor 52. Thereafter, the processor 61 acquires and processes the detection value of the acceleration sensor 52 as the acceleration value in a predetermined sampling cycle. At step S402, the processor 61 starts acquisition of the detection value of the atmospheric pressure sensor 51. Thereafter, the processor 61 acquires and processes the detection value of the atmospheric pressure sensor 51 as the atmospheric pressure value in a predetermined sampling cycle.

At step S403, the processor 61 determines whether any change in acceleration corresponding to a tap operation has been detected. The process repeats step S403 until change in acceleration corresponding to a tap operation is detected. When change in acceleration corresponding to a tap operation is detected, the process proceeds to step S404.

At step S404, the processor 61 determines whether any change in atmospheric pressure corresponding to a tap operation has been detected. When no change in atmospheric pressure corresponding to a tap operation has been detected, the process returns to step S403. Specifically, at step S404, it is determined that no tap operation is performed, and detection of change in acceleration corresponding to a tap operation is waited again at step S403. When change in atmospheric pressure corresponding to a tap operation is detected at step S404, the process proceeds to step S405.

At step S405, the processor 61 specifies that, a tap has been detected. In this state, at step S107 of the main process explained with reference to FIG. 4, it is determined that a tap operation has been performed, and a predetermined operation corresponding to a tap operation is performed at step S108.

Thereafter, the process returns to step S403, and the process relating to detection of a tap operation as described above is repeated, until the next tap operation is detected.

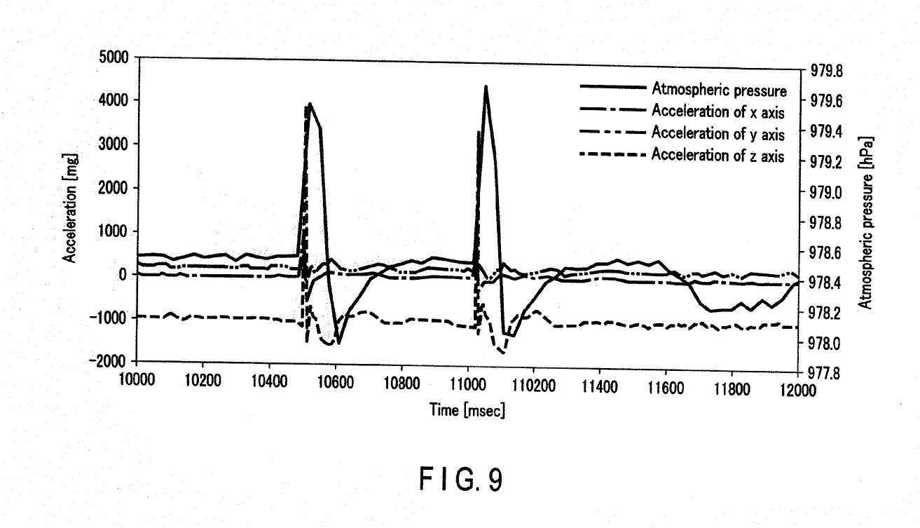

FIG. 9 illustrates an example of the detection value of the acceleration sensor 52 and the detection value of the atmospheric pressure sensor 51 with lapse of time when the wearable sensor 1 is tapped in the z axis direction. The solid line indicates change in atmospheric pressure. Because the acceleration sensor 52 is a triaxial sensor, the acceleration sensor 52 is capable of detecting acceleration of each of the x axis, the y axis, and the z axis. In FIG. 9, change in acceleration in the x axis direction is indicated with a dashed-dotted line, change in acceleration in the y axis direction is indicated with a dashed-two dotted line, and change in acceleration in the z axis direction is indicated with a broken line. At the time around 10500 msec, the acceleration in the z axis direction indicated with a broken line rapidly changes. In this method, the processor 61 detects such a rapid change as change in acceleration corresponding to a tap.

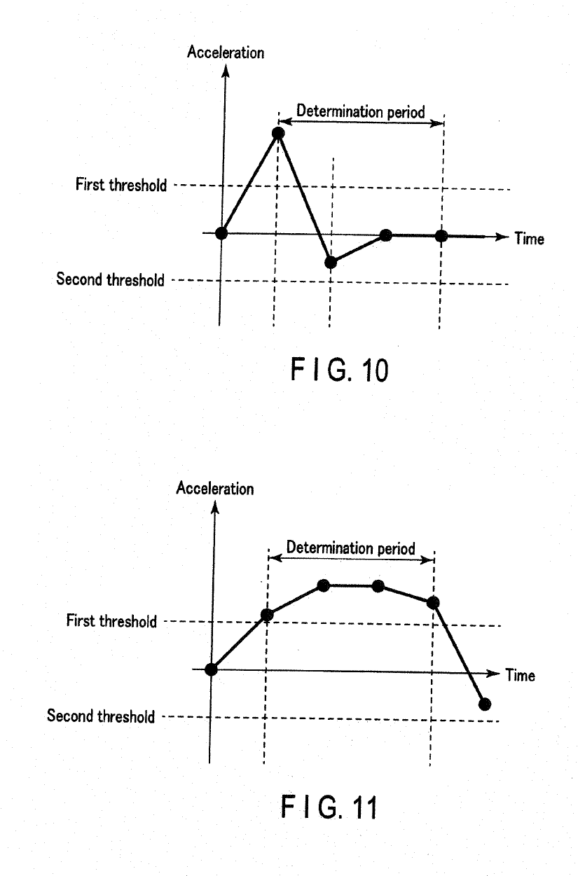

The following is a further explanation of an example of the method for detecting change in acceleration corresponding to a tap, with reference to FIG. 10 and FIG. 11. FIG. 10 and FIG. 11 illustrate change in acceleration detected with respect to lapse of time. In this method, a first threshold and a second threshold are set for acceleration. The first threshold and the second threshold are distant by a predetermined value from acceleration detected in a static state. In addition, a predetermined determination period is set in this method. In this method, as illustrated in FIG. 10, the processor 61 detects change in acceleration exceeding the first threshold or the second threshold, and thereby starts the determination period. In addition, when the acceleration falls within a range between the first threshold and the second threshold within the determination period, the processor 61 determines that change in acceleration corresponding to a tap has occurred. By contrast, as illustrated in FIG. 11, the processor 61 starts the determination period when the acceleration changes to exceed the first threshold or the second threshold, and determines no change in acceleration corresponding to a tap has occurred, when the acceleration does not fall within the range between the first threshold and the second threshold within the determination period. By such determination, the present method discriminates change in acceleration corresponding to a tap from other changes in acceleration.

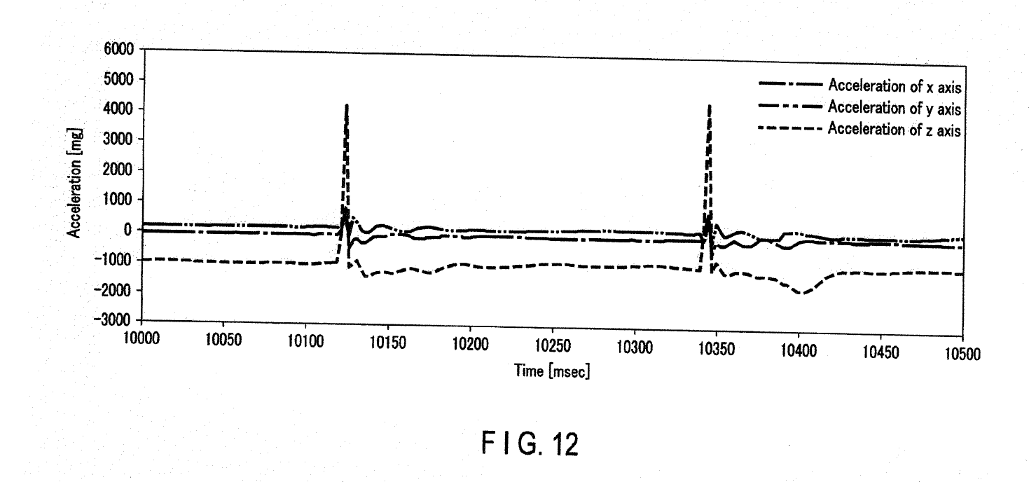

FIG. 12 illustrates an example of change in acceleration detected when the wearable sensor 1 is tapped in the z axis direction with respect to lapse of time. As illustrated in FIG. 12, when the wearable sensor 1 is tapped, rapid change in acceleration is measured. As an example of the present embodiment, change in acceleration relating to a tap operation is detected by the method explained with reference to FIG. 10 and FIG. 11.

Any method may be used as the method for detecting a tap using acceleration, as long as it is a method enabling discrimination of change in acceleration caused by a tap operation from changes in acceleration caused by other reasons.

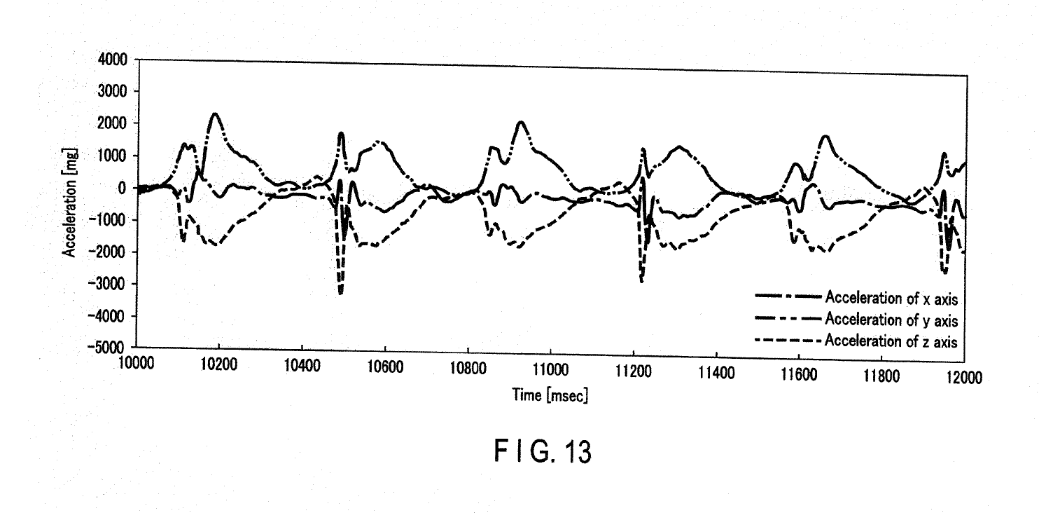

Change in acceleration relating to a tap operation can be detected accurately to some extent, by detection of change in acceleration as described above. However, there are cases where change caused by a tap operation cannot be accurately discriminated from changes caused by other reasons, only with change in acceleration. FIG. 13 illustrates change in acceleration detected when the wearer of the wearable sensor 1 is running, with respect to lapse of time. Also in FIG. 13, change in acceleration similar to that of FIG. 12 occurs in the z axis direction, and this change may be erroneously detected as a tap. For this reason, the present method also uses change in atmospheric pressure as well as change in acceleration, to discriminate a tap operation from others.

As recognized at the point in time around 10500 msec in FIG. 9, when a tap operation is performed, a rapid change in atmospheric pressure is detected as explained in the first method, together with a rapid change in acceleration, in the present method, it is determined that a tap operation has been performed, when both change in acceleration and change in atmospheric pressure corresponding to a tap operation have been detected.

The explanation described above illustrates the case of detecting change in atmospheric pressure after detection of change in acceleration, but the order of detection of change in atmospheric pressure and detection of change in acceleration may be reversed, or the detections may be performed simultaneously.

The explanation described above illustrates an example of the case where a tap is performed in the z axis direction of the wearable sensor 1, but the direction in which the wearable sensor 1 is tapped may be any direction, such as the x axis direction, the y axis direction, and other directions. Specifically, any surface of the wearable sensor 1 may be tapped. Because acceleration corresponding to the tap direction is detected, the processor 61 analyzes the detection value of acceleration of each of the axes.

As described above, for example, the processor 61 acquires the acceleration value detected with the acceleration sensor 52, performs second determination as to whether the acceleration value has changed with the second pattern explained with reference to FIG. 10, and specifies that the housing 19 has been tapped, on the basis of a result of first determination as to whether the atmospheric pressure has changed with the first pattern as described above and a result of the second determination.

The third method as described above enables determination of a user's input of tapping the wearable sensor 1, like the first method and the second method, on the basis of changes with time of the detection results of the acceleration sensor 52 and the atmospheric pressure sensor 51. In addition, the third method enables achievement of accurate detection of a tap operation, because detection results of both change in acceleration and change in atmospheric pressure are used for determination.

### <Fourth Method>

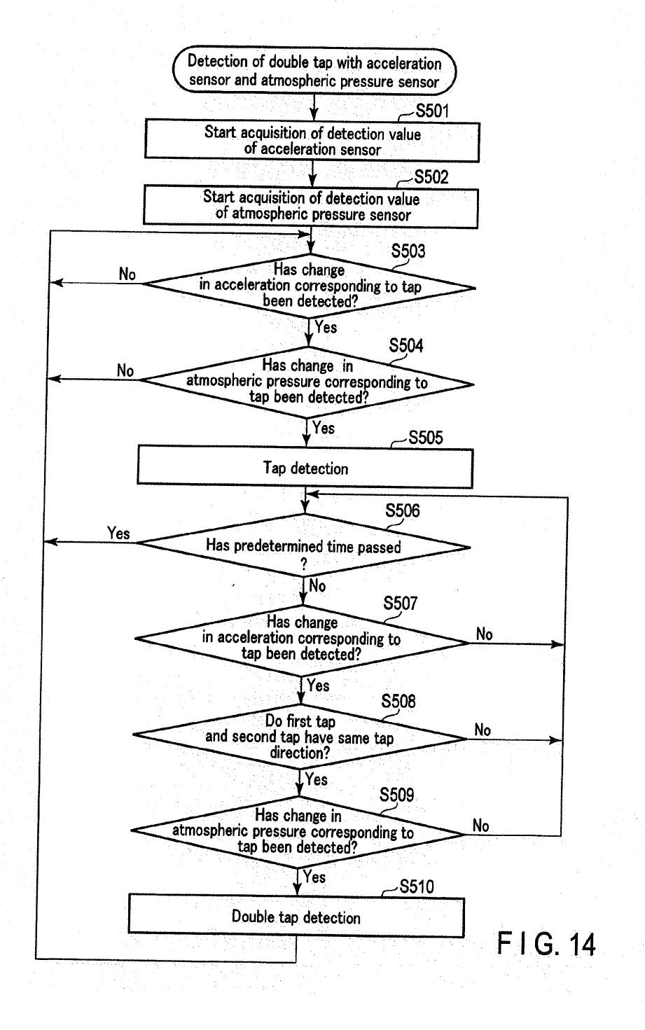

The following is a method for detecting a double cap using the detection value of the acceleration sensor 52 and the detection value of the atmospheric pressure sensor 51, as the fourth method, with reference to the flowchart illustrated in FIG. 14. Detection of a double tap is performed using detection of a tap operation using the acceleration sensor 52 and the atmospheric pressure sensor 51 explained in the third method.

At step S501, the processor 61 starts acquisition of the detection value of the acceleration sensor 52. At step S502. the processor 61 starts acquisition of the detection value of the atmospheric pressure sensor 51. Thereafter, the processor 61 acquires and processes the detection value of the acceleration sensor 52 and the detection value of the atmospheric pressure sensor 51 in a predetermined sampling cycle.

At step S503, the processor 61 determines whether change in acceleration corresponding to a tap operation has been detected. The process repeats step S503 until change in acceleration corresponding to a tap operation is detected. When change in acceleration corresponding to a tap operation is detected, the process proceeds to step S504. At step S504, the processor 61 determines whether change in atmospheric pressure corresponding to a tap operation has been detected, when no change in atmospheric pressure corresponding to a tap operation is detected, the process returns to step S503. Specifically, in this state, it is determined that no tap operation is performed, and detection of change in acceleration corresponding to a tap operation is waited again at step S503. When change in atmospheric pressure corresponding to a tap operation is detected at step SS04, the process proceeds to step S505. At step S505, the processor 61 determines that a tap has been detected.

At step S506, the processor 61 determines whether a predetermined period has passed after the first tap has been detected. The predetermined period is set to, for example, 200 msec to 600 msec, but is not limited thereto. When no predetermined period has passed, the process proceeds to step S507.

At step SS07, the processor 61 determines whether change in acceleration corresponding to a tap operation has been detected. When no change in acceleration corresponding to a tap operation has been detected, the process returns to step S506. Specifically, the processing at step SS06 and the processing at step S507 are repeated, until the predetermined period passes, or change in acceleration corresponding to a second tap operation is detected.

When it is determined at step S507 that change in acceleration corresponding to a tap operation has been detected, the process proceeds to step S508. At step S508, the processor 61 determines whether the direction of change in acceleration detected as the first tap at step S503 is the same as the direction of change in acceleration detected as the second tap at step S507. When a double tap operation is performed, because the user successively taps the wearable sensor 1 twice in the same direction, the first and the second detected changes in acceleration have the same direction. Specifically, because the same surface of the wearable sensor 1 is successively tapped twice, the changes in acceleration are detected at the same axis, and the changes in acceleration have the same sign (positive or negative). When it is determined that, the first tap and the second tap have different directions, the process returns to step S506. Specifically, the processing at step S506 and the processing at step S507 are repeated, until the predetermined period passes, or change in acceleration corresponding to a second tap operation is detected.

At step S506, when it is determined that the first tap and the second tap have the same direction, the process proceeds to step S509. At step S505, the processor 61 determines whether change in atmospheric pressure corresponding to a tap operation has been detected. When no change in atmospheric pressure corresponding to a tap operation has bean detected, the process returns to step SS06. Specifically, the processing at step S506 and the processing at step S507 are repeated, until the predetermined period passes, or change in acceleration corresponding to a second tap operation is detected.

At step SS09, when change in atmospheric pressure corresponding to a tap operation has been detected, the process proceeds to step S510. At step S510, the processor 61 determines that a double tap has been detected. In this state, at step S107 of the main process explained with reference to FIG. 4, it is determined that a double tap operation has been performed, and a predetermined operation corresponding to a double tap operation is performed at step S108.

For example, also in the example of the detection result illustrated in FIG. 9, two successive changes in acceleration in the same direction are detected, within the predetermined period set to, for example, 200 msec to 600 msec, at the time around 10500 msec and the time around 11000 msec thereafter. In both of them, change in atmospheric pressure is also detected, as well as change in acceleration. In such a case, the processor 61 specifies that a double tap has been performed.

The fourth method as described above enables determination of a user's input of tapping the wearable sensor 1, like the first to the third methods, on the basis of changes with time of the detection results of the acceleration sensor 52 and the atmospheric pressure sensor 51. In addition, the fourth method enables achievement of accurate detection of a tap operation, because detection results of both change in acceleration and change in atmospheric pressure are used for determination, in the same manner as the third method. Besides, the fourth method enables detection of a single tap and a double tap. In the same manner as the second method, different operations may be assigned to the single tap and the double tap. This configuration enables detection of two types of operations, by determining a single tap and a double tap discriminated from each other. As another example, no operation may be assigned to a single tap, and an operation may be assigned to only a double tap. In this case, when two taps are not detected within the predetermined period, the tap is not detected as an operation. This configuration reduces erroneous detection and improves detection accuracy, in comparison with detection of a single tap. Accordingly, this configuration enables achievement of more accurate detection of a tap operation.

This description illustrates an example of a double tap in which the wearable sensor 1 is successively tapped twice, but the number of successive taps may be any number.

### [Modification]

The explanation described above illustrates the case where acceleration changes only in the 2 axis direction, as an example, but the tap operation on the wearable sensor 1 may be performed in any direction. In the case where the acceleration sensor 52 is a triaxial acceleration sensor, the acceleration sensor 52 is capable of detecting change in acceleration of any of the directions. In addition, when the acceleration sensor 52 is a triaxial acceleration sensor, the acceleration sensor 52 is capable of discriminating a tap in the x axis direction, a tap in the y axis direction, and a tap in the z axis direction from each other. Specifically, this configuration enables determination as to which surface of the wearable sensor 1 has been tapped. Accordingly, different operations can be assigned to the respective tap operations of different directions. For example, sound playback is assigned to a tap on a surface perpendicular to the z axis, increase in sound volume is assigned to a tap on a surface perpendicular to the x axis, and decrease in sound volume is assigned to a tap on a surface perpendicular to the y axis.

In the explanation described above, the processor 61 specifies that a tap has been detected, when each of the atmospheric pressure, value of the atmospheric pressure sensor 51 and the acceleration value of the acceleration sensor 52 has changed with a pattern corresponding to a tap operation, but a pattern that is not a tap operation may be stored in advance, to specify that a tap has been detected, when each of the atmospheric pressure value and the acceleration value does net agree with the pattern that is not a tap operation.

In addition, tap detection according to the present embodiment is not limited to detection in a wearable sensor acquiring information relating to position and attitude. The technique according to the present embodiment may be applied to various types of information processing apparatuses including an atmospheric pressure sensor, or an atmospheric pressure sensor and an acceleration sensor, such as a wristwatch, a smartphone, a digital camera, and an electronic information terminal.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A tap detection device comprising:
a housing;
an atmospheric pressure sensor provided inside the housing and configured to detect atmospheric pressure inside the housing;
a processor; and
a storage storing a program to he executed with the processor,
wherein
the processor is configured to perform, with the program stored in the storage:
atmospheric pressure value acquisition, processing acquiring an atmospheric pressure value detected with the atmospheric pressure sensor; and
tap detection processing specifying a tap on the housing, based on a result of first determination as to whether the atmospheric pressure value has changed with a predetermined first pattern.

2. The tap detection apparatus according to claim 1, wherein, in the tap detection processing, the processor is configured to determine that the atmospheric pressure value has changed with the first pattern, when the atmospheric pressure value has changed with a predetermined pattern a plurality of times within a predetermined period, as the first determination.

3. The tap detection device according to claim 1, further comprising:
an acceleration sensor provided inside the housing,
wherein
the processor is further configured to
perform acceleration value acquisition processing acquiring an acceleration value detected with the acceleration sensor, and
specify a tap on the housing, based or the result of the first determination and a result of second determination as to whether the acceleration value has changed with a predetermined second pattern, in the tap detection processing.

4. The tap detection device according to claim 3, wherein, in the tap detection processing, the processor is configured to
determine that the atmospheric pressure value has changed with the first pattern, when the atmospheric pressure value has changed with a predetermined pattern a plurality of times within a predetermined period, as the first determination, and
determine chat the acceleration value has changed with the second pattern, when the acceleration value has changed with a predetermined pattern a plurality of times within the predetermined period, as the second determination.

5. The tap detection device according to claim 3, wherein
the acceleration sensor is configured to be capable of detecting accelerations in a plurality of directions, and
the processor is configured to perform the second determination for each of the directions, in the tap detection processing.

6. The tap detection device according to claim 5, wherein the processor is configured to specify a plurality of tap types, based on the result of the second determination performed for each of the directions, in the tap detection processing.

7. The tap detection device according to claim 1, wherein the housing includes a waterproof and dustproof structure.

8. The tap detection device according to claim 7, further comprising:
a waterproof ventilation film provided on the housing and configured to maintain air permeability between inside and outside of the housing and waterproofness of the housing.

9. The tap detection device according to claim 1, wherein the processor is configured to specify a tap on the housing, when the atmospheric pressure value has changed with the first pattern, in the tap detection processing.

10. The tap detection device according to claim 3, wherein the processor is configured to specify a tap on the housing, when the atmospheric pressure value has changed with the first pattern, and the acceleration value has changed with the second pattern, in the tap detection processing.

11. A tap detection method for a tap detection device including a housing and an atmospheric pressure sensor provided inside the housing and configured to detect atmospheric pressure inside the housing, the method comprising:
acquiring an atmospheric pressure value detected with the atmospheric pressure sensor; and
specifying a tap on the housing, based on a result of first determination as to whether the atmospheric pressure value has changed with a predetermined first pattern.

12. A tap detection method according to claim 11, wherein the first pattern includes a plurality of changes of the atmospheric pressure value with a predetermined pattern within a predetermined period.

13. A tap detection method according to claim 11, wherein
the tap detection device further includes an acceleration sensor provided inside the housing,
the method further comprises acquiring an acceleration value detected with the acceleration sensor, and
the specifying a tap on the housing is based on the result of the first determination and a result of second determination as to whether the acceleration value has changed with a predetermined second pattern.

14. The tap detection method according to claim 13, wherein
the first pattern includes a plurality of changes of the atmospheric pressure value with a predetermined pattern within a predetermined period, and
the second pattern includes a plurality of changes of the acceleration value with a predetermined pattern within a predetermined period.

15. The tap detection method according to claim 13, wherein
the acceleration sensor is configured to be capable of detecting accelerations in a plurality of directions, and the second determination is performed for each of the directions.

16. The tap detection method according to claim 15, further comprising:
specifying a plurality of tap types, baaed on the result of the second determination performed for each of the directions.

17. A non-transitory computer-readable storage medium recording a program for a computer of a tap detection device including a housing and an atmospheric pressure sensor provided inside the housing and configured to detect atmospheric pressure inside the housing, the program including:
a code to cause the computer to acquire an atmospheric pressure value detected with the atmospheric pressure sensor; and
a code to cause the computer to specify a tap on the housing, based on a result of first determination as to whether the atmospheric pressure value has changed with predetermined first pattern.
